(19) United States
(12) Patent Application Publication
(10) Pub. No.: US 2011/0161089 A1
(43) Pub. Date: Jun. 30, 2011

(54) METHOD FOR PATENT VALUATION AND COMPUTER-READABLE STORAGE MEDIUM

(75) Inventors: CHUNG-HUEI KUAN, Taipei (TW); Sheng-Chung Liu, Taipei (TW); Shi-Cho Cha, Taipei (TW); Jeng-Ywan Jeng, Taipei (TW); Jing-Sheng Gau, Taipei (TW)

(73) Assignee: National Taiwan University of Science and Technology, Taipei (TW)

(21) Appl. No.: 12/853,454

(22) Filed: Aug. 10, 2010

(30) Foreign Application Priority Data
Dec. 30, 2009 (TW) 098145937

(51) Int. Cl. G06Q 99/00; G06F 17/30

(52) U.S. Cl. 705/1.1; 707/769; 707/E17.014

(57) ABSTRACT

The present invention provides a method for patent valuation, comprising steps of providing a patent group for establishing a citation network and selecting a cluster within the citation network, wherein the citation network comprises a plurality of links, each link is formed between any two patent cases having citation relationship with each other; afterwards, designating weighting value for each link connecting each pair of patent cases; finally, calculating a plurality of centrality indices with respect to the plurality of patent cases in the cluster respectively according to the weighting value of each link. By means of the method of the present invention, it is capable of obtaining a relative value or significance of a specific patent case with respect to the other patent cases within the cluster.

### FIELD OF THE INVENTION

The present invention relates to a method for patent valuation, and more particularly, to patent valuation method using a citation network.

### BACKGROUND OF THE INVENTION

In today's “Knowledge Economy”, industries have come to acknowledge that patent rights have considerable influence on their abilities to compete in the global markets, as the patent owners are protected by the “exclusive right” to prevent others from making, using, selling or offering for sale the product, or process of making the product, that is described by the patent claims. However, a successful utilization and commercialization of patents is akin to playing the lottery—while the reward from a successful patent can be vast, the chance of obtaining a truly successful patent is slim. In addition that many patents do not really protect commercial products, patents can be very costly to obtain and maintain. The question is: does the potential benefit of having patent protection justify the costs to obtain and maintain it? Obviously, applicants should spend their limited resources wisely in those profitable patents, i.e. only those patents whose values are larger than their maintenance costs. Thus, for those managing both patent applications and granted patents, it is essential to know the value of each patent sufficiently accurately if one is to make well-founded decisions about their management. Nevertheless, although valuation of a patent or patent application involves making judgments about the future that can be very difficult to practice, it is always wise to consider how and whether patents may contribute to business success before proceeding with product development.

Since patents can give the patent owners the “exclusive right” to prevent others from making, using, selling or offering for sale the product, or process of making the product, a company's products that are protected by a patent can enjoy monopolistic sales for a significant number of years and thus the competitiveness of the company is ensured. The aim of valuing both patent applications and granted patents is to enable those managing them to know their value sufficiently accurately and objectively to make well-founded decisions concerning their management in licensing, transferring, company-merging, or other business affairs. If the value of a patent is underestimated the company owning the patent could suffer a loss in licensing; but on the other hand, if the patent is overestimated, the will for establishing cross licensing in a technical cooperation agreement between rival companies could be adversely affected. Thus, if a patent can be accurately and objectively valued, such value can be used as a base for determining the amount of royalty in the technology transferring relating to such patent.

There are already several methods for valuing patents that are in nmon use in R&D institutions or industries. Among the most popular are the cost method and the market-based method. However, all those conventional patent valuation methods have significant drawbacks, that is, those conventional patent valuation methods always require considerable amount of manpower in tasks like data searching and industry analysis. To estimate the market value of a patent is not a easy task, since the market value of a patent, being ultimately a measure of the potential sale of products or services that use the technology which the patent claims, can only be acquired after plenty of data searching and industry analyzing, not to mention that the same patent can be valued differently based on the context for which the valuation is being performed. Thus, in performing a business affair like M&A, licensing negotiations or infringement damage settlements, the valuation of patents is often the key issues that the two parties involving in the business affair are arguing about.

Therefore, it is in need of an objective, quantitative, scientific and automatic patent valuation method for solving the aforesaid drawbacks with reduced cost.

### SUMMARY OF THE INVENTION

The object of the present invention is to provide a method for patent valuation, which is to create links between any two patent cases having citation relationship with each other according to a patent search result originated from a patent search operation defined by a search criterion, and thereafter, after designating a weighting value to each link to be used in an algorithm for calculating a plurality of centrality indices relating to the links, a relative value of significance of each paten case with respect to other patent cases included in the patent search result can be obtained.

An other object of the present invention is to provide a storage medium for storing a program of patent valuation method while enabling the stored program to be loaded into and thus performed by a computer so as to obtain a relative value of significance of a specific paten case with respect to other patent cases included a the patent search result in accordance with the patent valuation method.

In an embodiment, the present invention provides a method for patent valuation, which comprises the steps of: providing a patent group for establishing a citation network and selecting a cluster within the citation network, wherein the citation network comprises a plurality of links as each link is formed between any two patent cases having citation relationship with each other; afterwards, designating a weighting value for each link connecting its corresponding pair of patent cases; finally, calculating a plurality of centrality indices with respect to the plurality of patent cases in the cluster respectively according to the weighting value of each link.

In another embodiment, the present invention provides a storage medium for storing a program of patent valuation method while enabling the stored program of patent valuation method to be loaded into and thus performed by a computer, as the patent valuation method comprises the steps of: providing a patent group for establishing a citation network and selecting a cluster within the citation network, wherein the citation network comprises a plurality of links as each link is formed between any two patent cases having citation relationship with each other; afterwards, designating a weighting value for each link connecting its corresponding pair of patent cases; finally, calculating a plurality of centrality indices with respect to the plurality of patent cases in the cluster respectively according to the weighting value of each link.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart depicting the steps of a method for patent valuation according to the present invention.

FIG. 2 is a flow chart depicting the steps for forming a citation network according to an embodiment of the invention.

FIG. 3A shows a patent search result originated from a patent search operation defined by a key word as search criterion.

FIG. 3B shows a patent group relating to a target patent case P.

FIG. 4A to FIG. 4C are schematic diagrams showing clusters in a citation network.

FIG. 5A and FIG. 5B are schematic diagrams showing respectively how the weighting values are designated using SPLC and SPNP.

FIG. 6 is a schematic diagram showing the links in a weighted citation network.

FIG. 7 is a schematic diagram showing relative values according to an embodiment of the present invention.

FIG. 8A to FIG. 8C show various citation networks being formed according to different embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

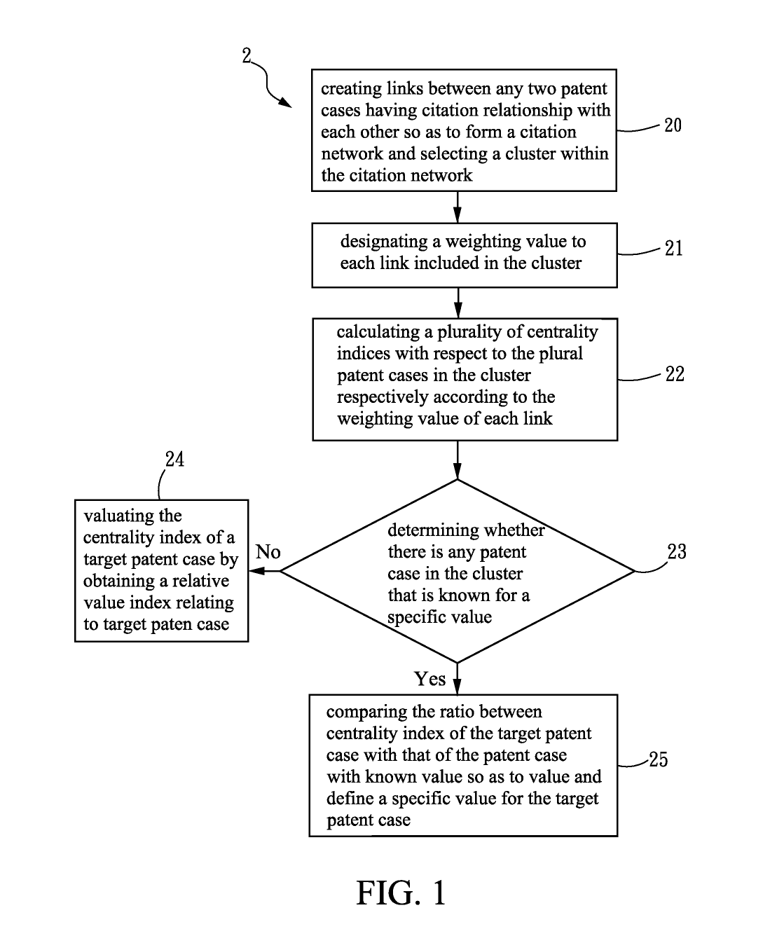

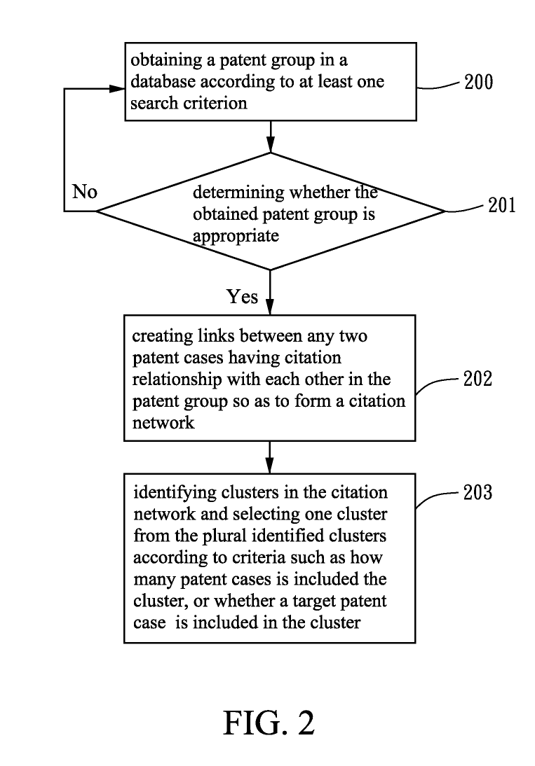

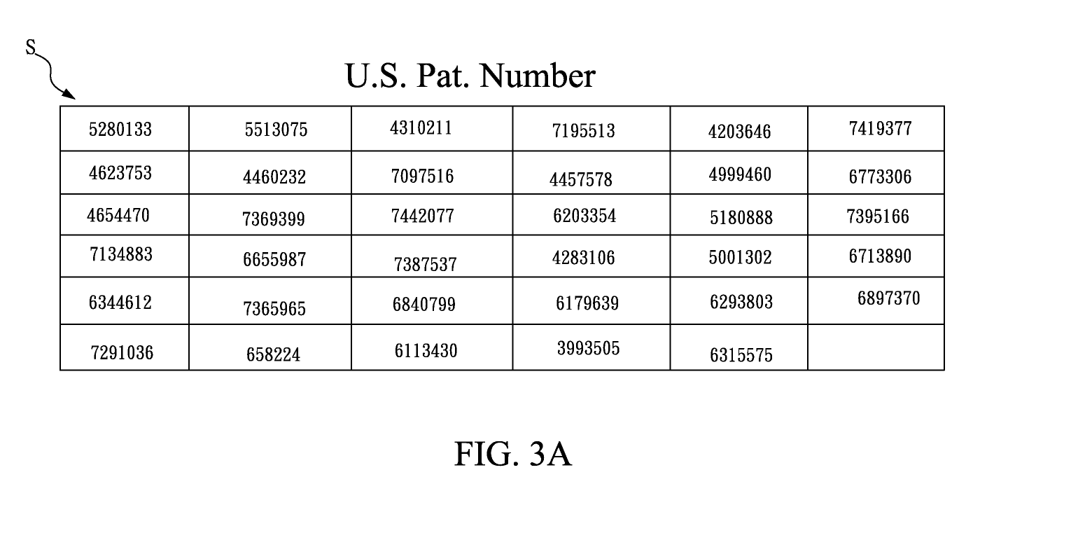

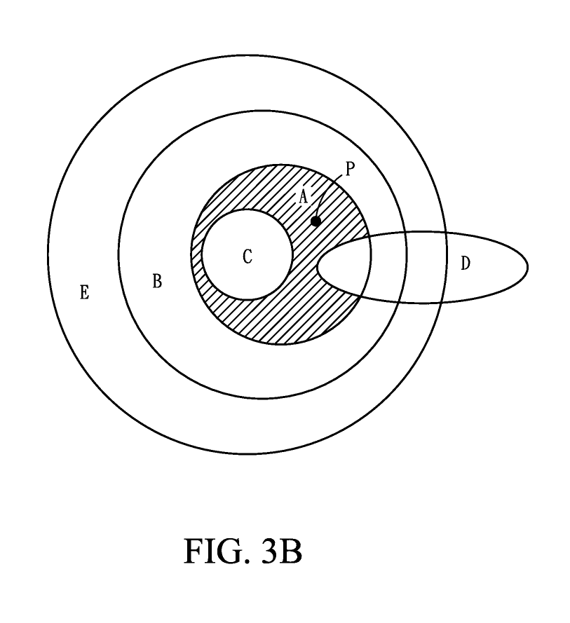

Please refer to FIG. 1, which is a flow chart depicting the steps of a method for patent valuation according to the present invention. The patent valuation method 2 in FIG. 1 starts from the step 20. At step 20, a patent group is provided for establishing a citation network and then a cluster within the citation network is selected, in that the citation network comprises a plurality of links as each link is formed between any two patent cases having citation relationship with each other; and then the flow proceeds to step 21. Please refer to FIG. 2, which is a flow chart depicting the steps for forming a citation network according to an embodiment of the invention. The establishing of the citation network, as shown in FIG. 2, starts from the step 200. At step 200, a patent group containing a plurality of patent cases is obtained by searching a database according to at least one search criterion; and then the flow proceeds to step 201. It is noted that the database can be a patent database of any country, such as USPTO patent database and EPO patent database, or can be a commercial database, such as Delephion patent database. Moreover, the search criterion used in the aforesaid step 20 can include key words, International patent classification (IPC) codes, application numbers, publication numbers, issued numbers, applicants, inventors or the combination thereof, but is not limited thereby. The result of the step 20 is illustrated in FIG. 3A, which shows a patent search result originated from a patent search operation defined by key words as search criterion. As shown in FIG. 3A, the group of a plurality of patent cases resulting from the search performed in step 200 is the patent group S for the step 20. It is noted that the U.S. Patent numbers are used in the patent group S only for illustration, they can be patent application numbers or patent numbers of any country that is not restricted to the United State of American. However, since the U.S. Patent Full-text database is the only free database with complete citation information available today, the patent valuation method provided in the present invention is now only applicable to the U.S. Patent Full-text database.

After completing the step 200, the flow proceeds to step 201. At step 201, an evaluation is made to determine whether the obtained patent group S is appropriate; if so, the flow proceeds to step 202; otherwise, the flow proceeds back to step 200. One way of making the evaluation is based upon whether there is a sufficient amount of patent cases in the patent group S; and when the amount of patent case in the patent group S is considered to be not sufficient or to be too numerous, the flow will proceeds back to step 200 where the search is performed again with another search criterion as the original search criterion is not appropriate. There is no specific number to be used as the threshold as it is determined according to actual requirement.

Another way of making the evaluation is to establish a benchmark set, which should include at least one target patent case P of known relevance. Thereby, when performing of the step 201 for determining whether the obtained patent group S is appropriate, the evaluation is based upon whether the patent cases in the benchmark set are included in the patent group S originated from a search criterion; and if there is any patent case in the benchmark set being excluded from the patent group S, an conclusion that the search criterion is not appropriate is reached. Similarly, the target patent case P can be an pre-granted patent publication or a granted patent case.

Please refer to FIG. 3B, which shows a patent group relating to a target patent case P. In FIG. 3B, the shadowed area A represents the most appropriate patent group. However, if an inappropriate search criterion is used the search performed in step 200 might generate an inappropriate patent group C or D, by which certain patent cases that are of significant importance to the patent valuation are missed. Nevertheless, if appropriate search criterion is used, the patent group B or E might be obtained, which has the patent group A being included therein.

After an appropriate search criterion is achieved and the patent group S resulting therefrom is determined to be appropriate, the flow of FIG. 2 will proceeds to step 202. At step 202, links between any two patent cases having citation relationship with each other in the patent group S are created so as to form a citation network; and then the flow proceeds to step 203. When a patent case A is cited by another patent case B, it is known that there must be a piece of knowledge disclosed in the patent case A is related to the patent case B, that is, the patent case A may be an improvement over the patent case B, or even the two patent cases A and B are simply two different ways for handling the same problem. In the view of information flow, one can image that there is a piece of knowledge flowing from the patent case A to the patent case B, which can be represented by an arrow pointing from a node of patent case A toward another node of patent case B. It is noted that the citation relationship can be established by forward citation or backward citation.

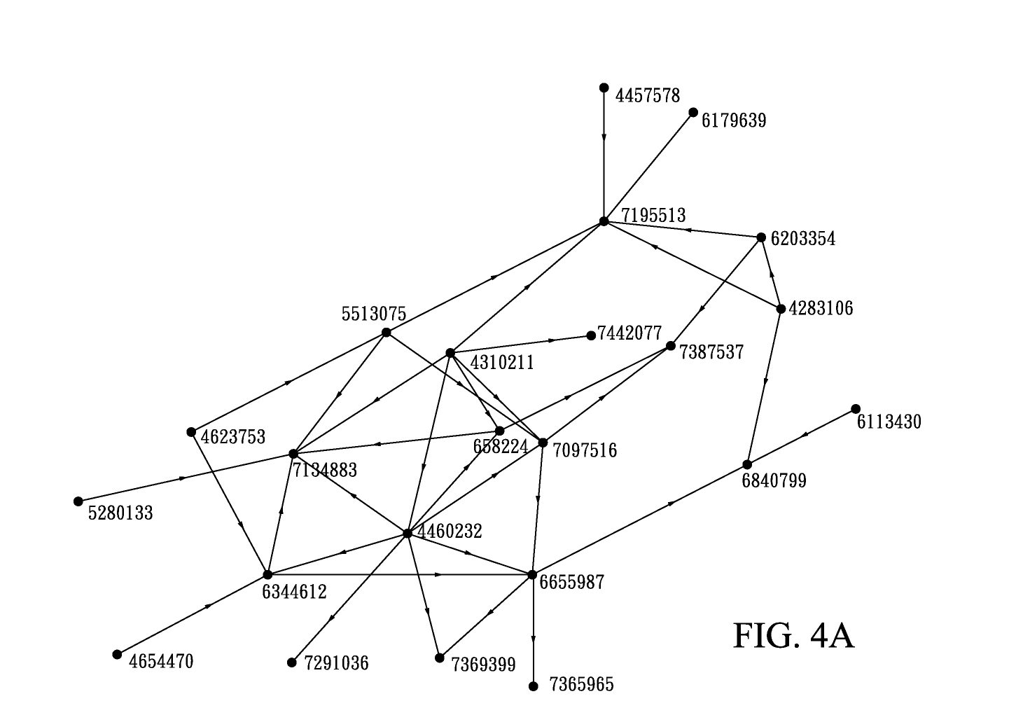

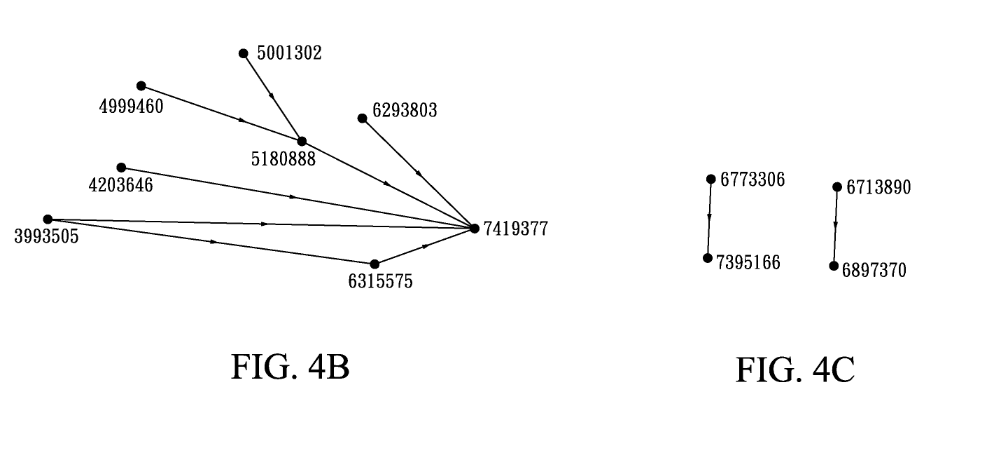

Please refer to FIG. 4A to FIG. 4C, which are schematic diagrams showing clusters in a citation network. According to the search result of FIG. 3A, the citation network obtained from the step 202 might include one or more clusters, such as the three clusters shown in FIG. 4A to FIG. 4C. It should be obvious that any two patent cases in the same cluster are definitely related to each other either directly or indirectly. Then, at step 203, clusters in the citation network are identified and one cluster is selected from the plural identified clusters according to the criteria such as how many patent cases is included each cluster, or whether a target patent P is included in the cluster.

Assuming the U.S. Pat. No. 4,310,211 is the target patent case P, there are three different situations may occur, which are, the first, the target patent case P can not be found in any cluster of the citation network; the second, the target patent case P is indeed existed in one cluster of the citation network, but the amount of patents included in the cluster with the target patent case P is not sufficient, such as the clusters shown in FIG. 4B and FIG. 4C; and the third, the target patent case P is indeed existed in one cluster in the citation network, whereas the cluster has sufficient amount of patent cases, as the one shown in FIG. 4A. When the first two situations occur, the search criterion is determined to be inappropriate and the flow will proceeds back to step 20 for starting another search with new search criterion. In this example, both the clusters shown in FIG. 4B and FIG. 4C do not include the target patent case P, but is included in the cluster shown in FIG. 4A, so that the cluster of FIG. 4A is used as the citation network as it has sufficient amount of patent cases while the two clusters shown in FIG. 4B and FIG. 4C are excluded from the following patent valuation. It is noted that as the citation network might be composed of one or more clusters, whereas each cluster in a citation network can be considered a sub-network. That is, a cluster itself can be considered a citation network, and thus, the terms of “citation network” and “cluster” in this invention are actually interchangeable.

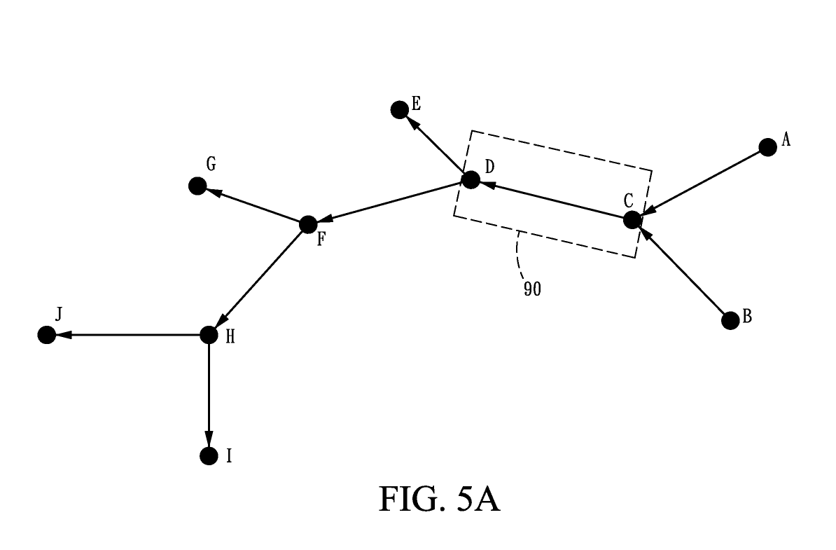

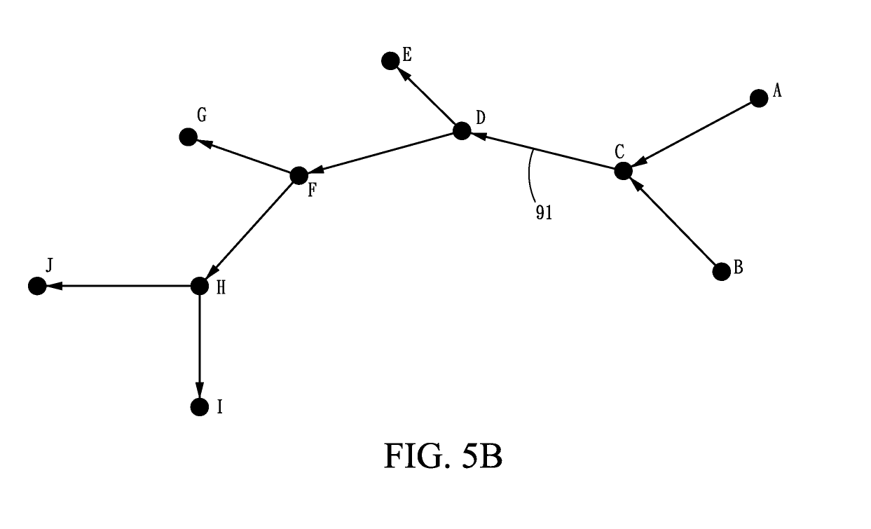

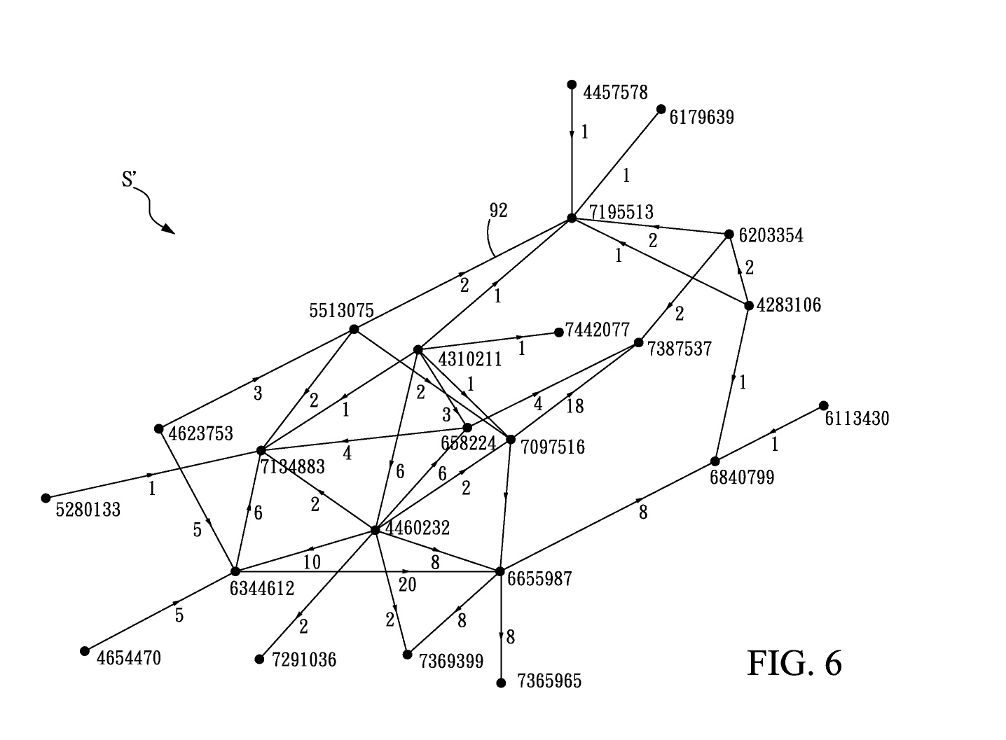

Back to FIG. 1 where the step 20 is completed, the flow will proceed to step 21. At step 21, a weighting value is designated to each link included in the cluster; and then the flow proceeds to step 22. There are various ways for designating weighting values to the links. One of which is to designate a value of 1 as the weighting value for each link. On the other hand, the designating of the weighting value for each link can be performed by a means selected from the group consisting of: a means of search path link count (SPLC), and a means of search path node pair (SPNP). Please refer to FIG. 5A and FIG. 5B, which are schematic diagrams showing respectively how the weighting values are designated using SPLC and SPNP. In FIG. 5A, a SPLC method is used for designating a weighting value to a link 90 that is described as following: as the link 90 connected a node of patent case C to another node of patent case D, and there are four terminal nodes E, G, I, and J located on the left of the link 90 that can be reached through the link 90 and two terminal nodes A and B located on the right of the link 90 that can reach the link 90, the weighting value of the link 90 can be designated as 4×2=8. In FIG. 5C, a SPNP method is used for designating a weighting value to a link 91 that is described as following: as the link 91 connected a node of patent case C to another node of patent case D, and for the node D, there are three nodes A, B, and C capable of reaching the node D through the link 91; and for the node C, there are seven nodes D˜J capable of being reached from the node C through the link 91, the weighting value of the link 91 can be designated as 3×7=21. Accordingly, an example of the designation of weighting values performed in step 21 is illustrated in FIG. 6.

After the step 21 for designating weighting values is completed, the flow will proceed to step 22. At step 22, an operation is performed for calculating a plurality of centrality indices with respect to the plural patent cases in the cluster S′ respectively according to the weighting value of each link; and then the flow proceeds to step 23. In this embodiment, each of the centrality indices is an eigenvector centrality (EC). As the patent citation network can be considered a kind of social network in a broad sense, the importance of each node in the network can be evaluated using centrality which is an important concept for analyzing social network. In this embodiment, eigenvector centrality which is applicable to a directional and weighted network is used for measuring the importance in the citation network. The eigenvector centrality has a unique characteristic that a node's importance is proportional to those pointed by the node. Thus, the importance of a patent case in the citation network is increased if the patent case is cited by another importance patent case. Therefore, a patent case of high centrality is not determined by its citation count, but by where it is located in the citation network.

Eigenvector centrality is a measure of the importance of a node in a network. It assigns relative scores to all nodes in the network based on the principle that connections to high-scoring nodes contribute more to the score of the node in question than equal connections to low-scoring nodes. Let Iⱼ denote the rank score of the ith node. Let A_{i,j} be the weighting value of the link pointing from the ith node to the jth node, and A_{i,j}=0 if there is no link from the ith node to the jth node. For the jth node, the centrality score is proportional to the sum of the scores of all nodes which are connected to it. Hence

$$c \cdot {I}_{j} = {\sum }_{k} {A}_{jk} \cdot {I}_{k} \qquad ( 1 )$$

wherein c is a constant.
   In vector notation, the equation (1) can be rewritten as:

C·I=A·I (2)
wherein C is the eigenvalue of the matrix A; and
   I is the eigenvector.
      In general, there will be more than one solutions and the eigenvector I corresponding to the largest eigenvalue is most significant. Thus, taking the cluster S′ shown in FIG. 6 for example, the eignevector I is the vector matrix containing nodes of patent cases, while each element A_{i,j} in the matrix A is the weighting value of the link 92 pointing from the node i to the node j. For those elements in the matrix A that are diagonally aligned, their values are equal to zero since they represents those node being linked back to themselves.

For solving the equation (2), power iteration is one of many eigenvalue algorithms that may be used to find this dominant eigenvector. Thus, it is required to assign an initial value for each element in the eignevector I. Theereafter, since all the elements in the matrix A are already given, the eignevalue C can be calculated, and then, the value of each element in the eignevector I is adjusted for the next iteration. Since every converged eigenvector is corresponding to one eigenvalue whereas the eigenvector corresponding to the greatest eigenvalue results in the desired centrality measure to be used for representing the importance of each node of FIG. 6. Accordingly, the relative importance of each node in the cluster S′ is obtained.

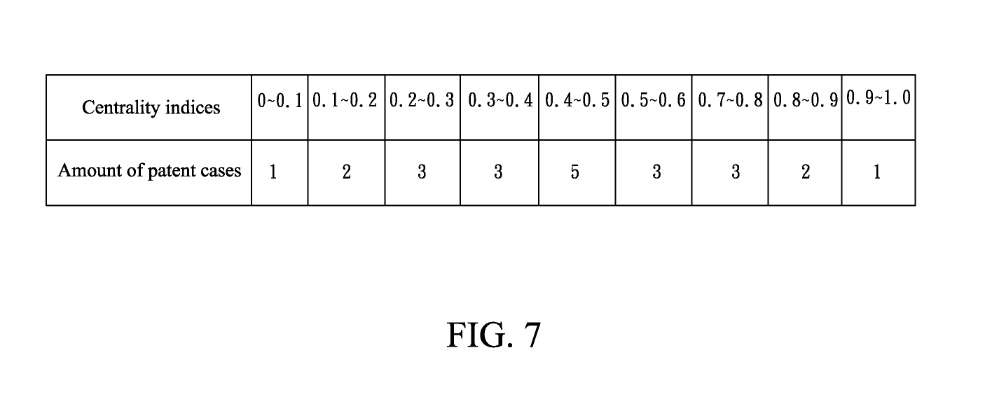

After the step 22 in FIG. 1 is completed, the flow proceeds to step 23. At step 23, an evaluation is made for determining whether there is any patent case in the cluster that is known of a specific value; if there is none, then the flow proceeds to step 25; otherwise, the flow proceeds to step 24. At step 24, an evaluation is made for obtaining a relative value index relating to a target paten case. Please refer to FIG. 7, which is a schematic diagram showing the evaluation of relative values according to an embodiment of the present invention. An exemplary percentile rank (PR) table can be established according to the values of all the elements in the eigenvector I, then a distribution of all patent cases in the cluster could be determined as illustrated. Thereby, an objective valuation regarding the target patent case P can be achieved and used for indicating the importance of the target patent case P in the cluster. For example, the centrality index of the target patent case P is located within the first 10% of all patent cases in the cluster by examining the PR table. On the other hand, when there are patents in the cluster with known values, the flow will proceed to step 25. At step 25, an operation is performed for comparing the ratio between centrality index of the target patent case with that of the patent case with known value so as to value and define a specific value for the target patent case.

It is noted that the aforesaid method for patent valuation including the steps 20 to 25 can be programmed and stored in a storage medium, and the program of the patent valuation method can be loaded into a computing device where it is executed. In this embodiment, the computing device can be a server, a workstation, a desktop computer or a notebook computer, while the storage medium can be an optic disc, a hard disc or a memory unit.

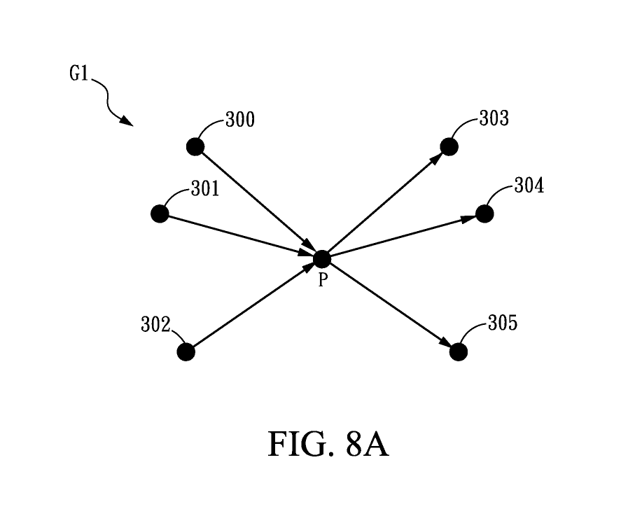

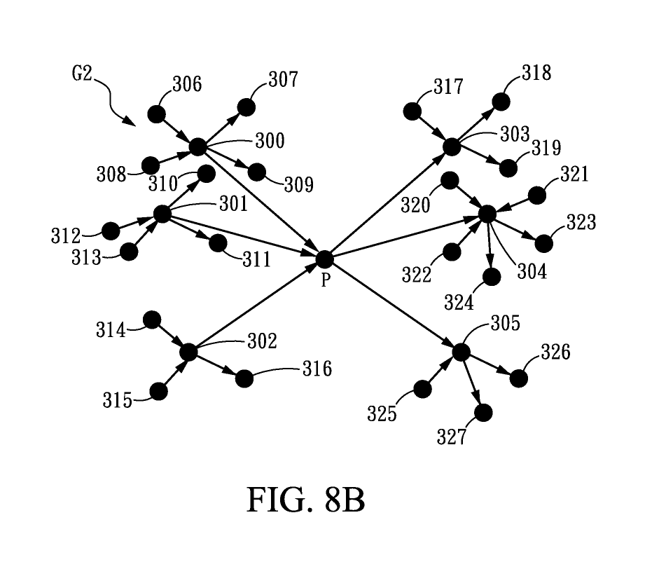

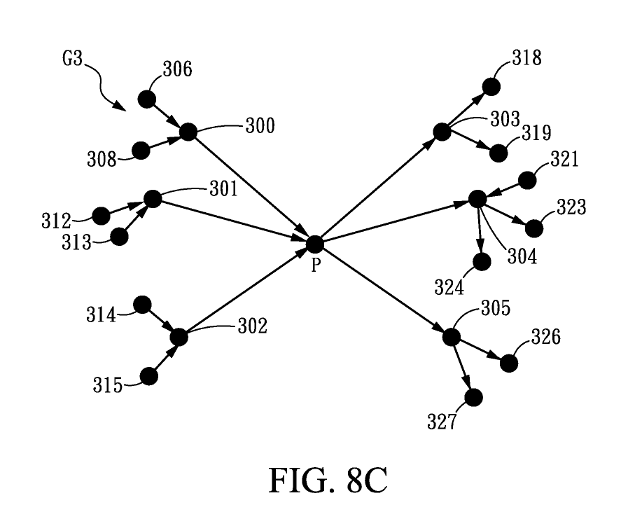

As described, in the detailed steps 200˜203 of the step 20, the method of the patent valuation is designed to form a citation network in a patent group resulting from a patent search operation defined by a search criterion and then a cluster is selected. The cluster that is selected from the citation network is identified according to how many patent cases is included the cluster, or whether a target patent case P is included in the cluster. However, the cluster can be formed directly originating from the target patent case P, as the cluster G1 shown in the embodiment of FIG. 8A. In FIG. 8A, the cluster G1 is a patent group of the first-order (direct) citations relating to the target patent case P which includes the target patent case P, those patent cases 300˜302 that are directly cited by the target patent case P in a so-called backward citation relationship, and those patent cases 303˜305 that have the target patent case P cited thereby in a so-called forward citation relationship. Nevertheless, the cluster G2 shown in the FIG. 8B is a patent group of the second-order citation relating to the target patent case P, which includes patent cases 300˜327 that are of first-order forward citation relationship with all the patent cases in the cluster G1, and of a first-order backward citation relationship with all the patents cases in the cluster G1, in addition to those included in the cluster G1.

For the citation network shown in FIG. 8C, the outward expanding ripple-like cluster G3 is formed by only including the patent cases 306, 308, 312˜315 that are of at least one-order backward citated (but not including those forward cited) by the patent cases 300˜302 whichever is backward cited to the target patent case P, and also those patent cases 318, 319, 321, 323, 324, 326, 327 that are of at least one-order forward citated (but not including those backward cited) by the patent cases 303˜305 whichever is forward cited to the target patent case P.

Accordingly, no matter how the clusters are being formed, they are all originated from the at least one target patent case P, and are suitable for those posterior steps. It is noted that the following steps 22˜25 are performed the same as those described in the foregoing embodiments, and thus will not be described further herein.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method for patent valuation, comprising the steps of:
providing a patent group having a plurality of patent cases for establishing a citation network and selecting a cluster within the citation network, wherein, within the citation network and the cluster, a link is formed between any two patent cases having citation relationship with each other;
designating a weighting value for each link connecting its corresponding pair of patent cases; and
calculating a plurality of centrality indices with respect to the plurality of patent cases in the cluster respectively according to the weighting value of each link.

2. The method of claim 1, wherein the designating of the weighting value for each link is performed by a means selected from the group consisting of: a means of search path link count (SPLC), and a means of search path node pair (SPNP).

3. The method of claim 1, wherein the weighting value being designated to each link is 1.

4. The method of claim 1, wherein eigenvector centrality (EC) is used for measureing the cetrality indices in the citation network.

5. The method of claim 1, further comprising the step of:
providing at least one target patent case wherein the target patent cases are included in both the patent group and the selected cluster.

6. The method of claim 5, further comprising the step of:
valuating a target patent case by obtaining a relative value index relating to the centrality index of the target paten case wherein the relative value index is the percentile rank of the centrality index among the cluster.

7. The method of claim 5, further comprising the step of:
comparing the ratio between the centrality index of the target patent case with that of a patent case with known value so as to define a specific value for the target patent case.

8. The method of claim 5, wherein the patent cases of the patent group are obtained by searching a database according to at least one search criterion.

9. The method of claim 8, further comprising the step of:
determining whether the patent group contains the target patent case; if not, adjusting the at least one search criterion for enabling another search so as to generate another patent group, and then repeating the present step.

10. The method of claim 5, wherein the patent group contains patent cases of at least one-order forward citated by the target patent case and patent cases of at least one-order backward cited by the target patent case.

11. The method of claim 10, wherein, for a first patent case directly or indirectly backward cited by the target patent case, only those patent cases backward cited by the first patent case are included in the patent group; and, for a second patent case directly or indirectly forward citing the target patent case, only those patent cases forward cite the second patent case are included in the patent group.

12. A storage medium for storing a program of patent valuation method while enabling the stored program of patent valuation method to be loaded into and thus performed by a computer, as the patent valuation method comprises the steps of:
providing a patent group having a plurality of patent cases for establishing a citation network and selecting a cluster within the citation network, wherein, within the citation network and the cluster, a link is formed between any two patent cases having citation relationship with each other;
designating a weighting value for each link connecting its corresponding pair of patent cases; and
calculating a plurality of centrality indices with respect to the plurality of patent cases in the cluster respectively according to the weighting value of each link.

13. The storage medium of claim 12, wherein eigenvector centrality (EC) is used for measureing the cetrality indices in the citation network.

14. The storage medium of claim 12, further comprising the step of:
providing at least one target patent case wherein the target patent cases are included in both the patent group and the selected cluster.

15. The storage medium of claim 14, further comprising the step of:
valuating a target patent case by obtaining a relative value index relating to the centrality index of the target paten case wherein the relative value index is the percentile rank of the centrality index among the cluster.

16. The storage medium of claim 14, further comprising the step of:
comparing the ratio between the centrality index of the target patent case with that of a patent case with known value so as to define a specific value for the target patent case.

17. The storage medium of claim 14, wherein the patent cases of the patent group are obtained by searching a database according to at least one search criterion.

18. The storage medium of claim 17, further comprising the step of:
determining whether the patent group contains the target patent case; if not, adjusting the at least one search criterion for enabling another search so as to generate another patent group, and then repeating the present step.

19. The storage medium of claim 14, wherein the patent group contains patent cases of at least one-order forward citated by the target patent case and patent cases of at least one-order backward cited by the target patent case.

20. The storage medium of claim 19, wherein, for a first patent case directly or indirectly backward cited by the target patent case, only those patent cases backward cited by the first patent case are included in the patent group; and, for a second patent case directly or indirectly forward citing the target patent case, only those patent cases forward cite the second patent case are included in the patent group.
